(19) United States
(12) Patent Application Publication
(10) Pub. No.: US 2025/0100060 A1
(43) Pub. Date: Mar. 27, 2025

(54) COMPRESSOR-MOUNTED ENGINE GENERATOR/WELDER

(71) Applicant: YAMABIKO CORPORATION, Tokyo (JP)

(72) Inventors: Akinobu KIMURA, Tokyo (JP); Toru FURUKAWA, Tokyo (JP); Takafumi FUROKAWA, Tokyo (JP)

(21) Appl. No.: 18/975,731

(22) Filed: Dec. 10, 2024

Related U.S. Application Data
(63) Continuation of application No. PCT/JP2022/024489, filed on Jun. 20, 2022.

(51) Int. Cl. B23K 9/10

(52) U.S. Cl. CPC B23K 9/1043

(57) ABSTRACT

A compressor-mounted engine generator/welder includes: an engine; a generator driven by the engine; a compressor configured to obtain compressed air; a first housing configured to accommodate the engine and the generator; and a second housing configured to accommodate the compressor. The first housing includes a coupling space to removably couple the second housing.

### CROSS-REFERENCE TO RELATED APPLICATIONS

The present application is a continuation application of PCT Internal Application No. PCT/JP2022/024489 filed on Jun. 20, 2022, and the entire contents of which are hereby incorporated by reference.

### BACKGROUND

### 1. Technical Field

The present invention relates to an engine-driven generator/welder equipped with a compressor.

### 2. Related Art

Conventionally, there has been known an engine generator/welder configured to convert the output of an engine-driven generator from an alternate current to a direct current to obtain welding power. In addition, when gouging is performed as a process of welding work, compressed air is required. Here, in order to obtain the compressed air, there has been known a compressor-mounted engine generator/welder which is an engine generator/welder equipped with a compressor. See Japanese Patent Application Laid-Open No. 2004-276115. The entire contents of this disclosure are hereby incorporated by reference.

The conventional compressor-mounted engine generator/welder includes an engine, a generator/welder, and a compressor accommodated in a single housing, and a gearbox configured to connect the generator to the engine, and connect the engine or the generator/welder to the compressor.

The driving force of the engine is transmitted to the generator/welder and the compressor via the gearbox.

### SUMMARY

The compressor-mounted engine generator/welder according to the invention includes: an engine; a generator driven by the engine; a compressor configured to obtain compressed air; a first housing configured to accommodate the engine and the generator; and a second housing configured to accommodate the compressor. The first housing includes a coupling space to removably couple the second housing.

### BRIEF DESCRIPTION OF THE DRAWINGS

FIG. 1 is a perspective view illustrating the appearance of a compressor-mounted engine generator/welder according to an embodiment of the invention;

FIG. 2 is a perspective view illustrating the compressor-mounted engine generator/welder according to an embodiment of the invention in a state where a second housing is separated from a first housing;

FIG. 3 is a side view illustrating the compressor-mounted engine generator/welder according to an embodiment of the invention in the state where the second housing is separated from the first housing;

FIG. 4 illustrates the internal constitution of the compressor-mounted engine generator/welder according to an embodiment of the invention; and

FIG. 5 illustrates an example of a side wall (front wall) of the compressor-mounted engine generator/welder according to an embodiment of the invention.

### DETAILED DESCRIPTION

In the conventional compressor-mounted engine generator/welder, the engine, the generator/welder, and compressor are accommodated in a single housing, so that the weight of the housing, including its contents, is inevitably quite large. This causes a problem that a large amount of labor is required to transport the machine.

In addition, the conventional compressor-mounted engine generator/welder drives the compressor by the power of the engine, and therefore the compressor is mechanically connected to the engine. This causes a problem that complicated work is required for the maintenance of the compressor to cancel the mechanical connection of the compressor and the engine, for example, by taking apart the gearbox, and therefore it is not easy to conduct the maintenance.

In addition, in the conventional compressor-mounted engine generator/welder, the compressor and the engine sometimes share an air cleaner. In this case, the engine cannot be started during the maintenance of the compressor. Therefore, during the maintenance of the compressor, it is not possible to use the generator/welder driven by the engine, and consequently to inevitably halt the welding work. This causes a problem that the on-site work is stopped for a long time due to the maintenance of the compressor.

Moreover, in the case of the conventional compressor-mounted engine generator/welder, the compressor is connected to the engine, and therefore when operation check is intended for the compressor independently during the maintenance, the engine must be started. Otherwise, it is not possible to check the operation of the compressor. This causes a problem that it is not easy to check the operation of the compressor independently during the maintenance.

The present invention is intended to address the above-described circumferences. Therefore, problems to be solved by the invention are to improve the portability of the compressor-mounted engine generator/welder; to improve ease of maintenance of the compressor-mounted engine generator/welder; to prevent the on-site work from being prolonged due to the maintenance by allowing the welding work to be continued even during the maintenance of the compressor of the compressor-mounted engine generator/welder; and to easily check the operation of the compressor independently in the compressor-mounted engine generator/welder.

Hereinafter, an embodiment of the present invention will be described with reference to the drawings. The same reference numbers in the different drawings indicate the same functional parts, and therefore repeated description for each of the drawings is omitted.

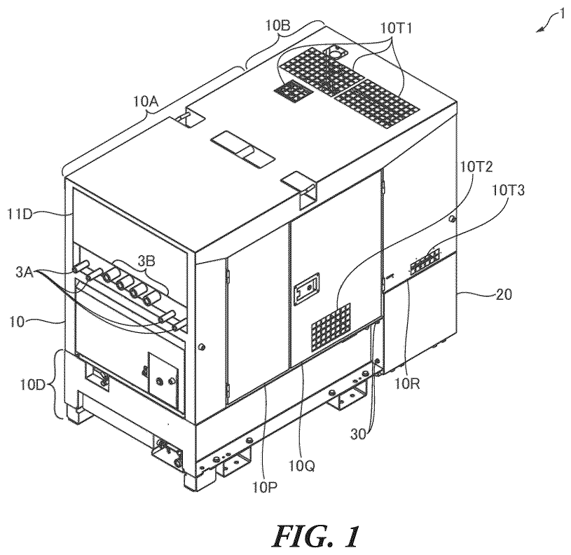

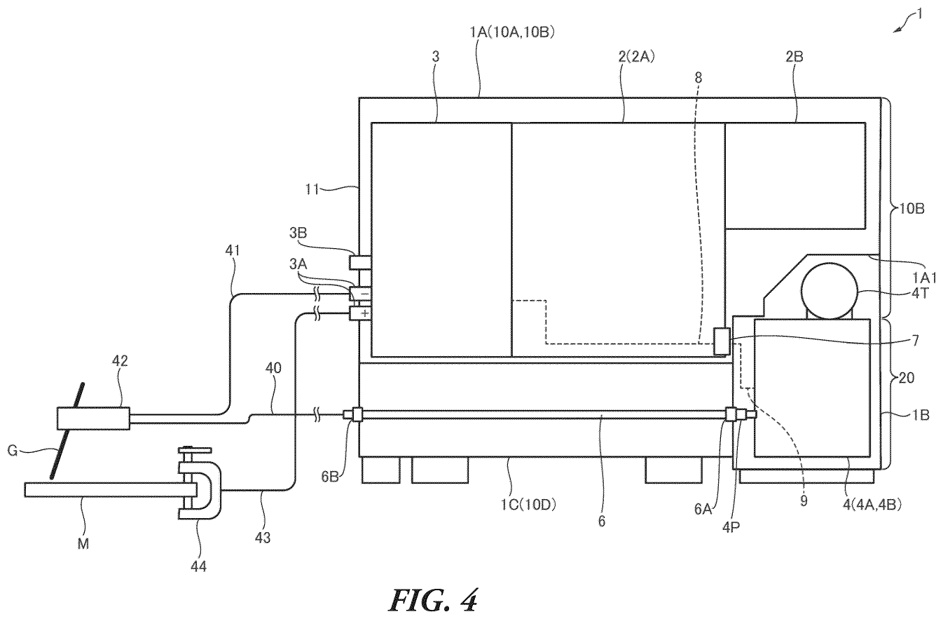

As illustrated in FIG. 1 to FIG. 3, a compressor-mounted engine generator/welder 1 according to an embodiment of the invention includes a first housing 10 and a second housing 20. The first housing 10 accommodates an engine 2 and a generator 3 illustrated in FIG. 4. The second housing 20 accommodates a compressor 4 illustrated in FIG. 4.

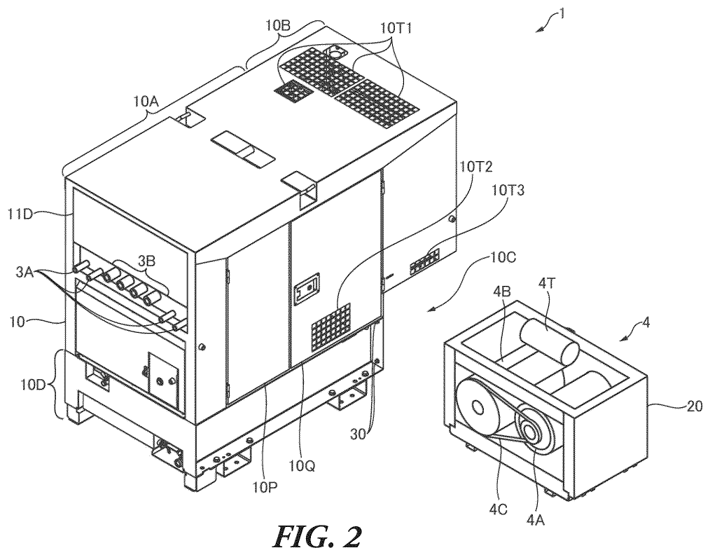

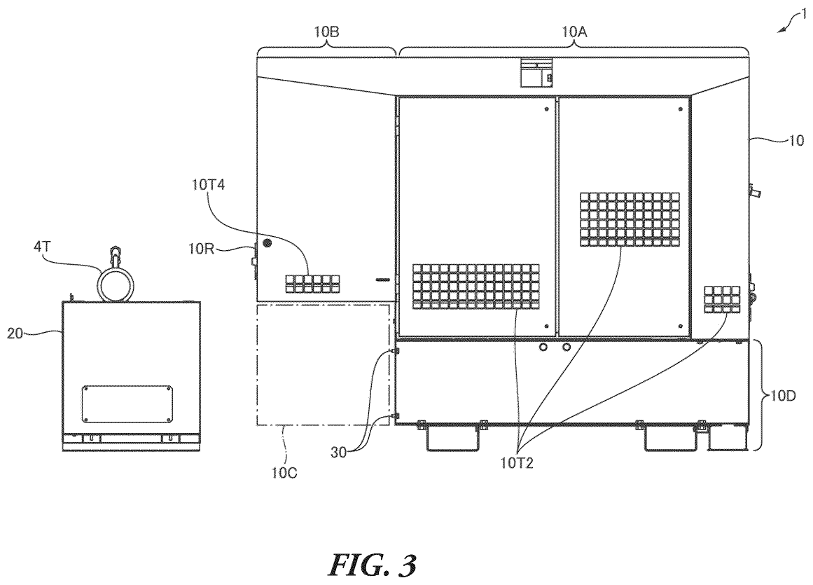

The first housing 10 and the second housing 20 can be coupled with one another to be unitized as illustrated in FIG. 1, and separated from one another as illustrated in FIG. 2 and FIG. 3. In this coupling state illustrated in FIG. 1, the second housing 20 is fixed to the first housing 10 with fastening members 30 such as bolts and screws. The second housing 20 can be separated from the first housing 10 by removing the fastening members 30 coupling the first housing 10 with the second housing 20.

The first housing 10 includes a protrusion part 10B protruding from a part of a main body 10A having approximately a rectangular parallelepiped shape. The main body 10A accommodates a main body 2A of the engine 2 and the generator 3, and the protrusion part 10B accommodates a muffler 2B of the engine 2 as illustrated in FIG. 4. A coupling space 10C is formed under the protrusion part 10B of the first housing 10. The second housing 20 is removably coupled with the coupling space 10C.

The first housing 10 accommodating the engine 2 and the generator 3 includes a pedestal 10D on which the main body 2A of the engine 2 and the generator 3 are placed, and the main body 10A is formed on the pedestal 10D. The protrusion part 10B protrudes toward a position far from the pedestal 10D to enclose the muffler 2B protruding laterally from the main body 2A of the engine 2. Accordingly, there is no pedestal 10D below the protrusion part 10B, and therefore a dead space is formed below the protrusion part 10B in the first housing 10 without the second housing 20. This dead space is utilized to form the coupling space 10C to removably couple the second housing 20.

Here, with the illustrated example, the coupling space 10C is formed outside the first housing 10, but this is by no means limiting. The coupling space 10C may be formed inside the first housing 10 as a part of the first housing 10. That is, the first housing 10 is formed in a rectangular parallelepiped shape, and the dead space formed in the first housing 10 may be utilized to form the coupling space 10C to couple the second housing 20.

The first housing 10 includes intake ports and exhaust ports provided at positions at which they are required. Exhaust ports 10T1 for the engine 2 and the generator 3 are provided on the upper surface of the first housing 10. Intake ports 10T2 for the engine 2 and the generator 3 are provided on side surfaces of the first housing 10. In addition, an exhaust port 10T3 and an intake port 10T4 for the compressor 4 are provided on the lower portion of the protrusion part 10B of the first housing 10. The first housing 10 includes opening and closing doors 10P and 10Q for the maintenance of the engine 2 and the generator 3 in the main body 10A. The protrusion part 10B includes an opening and closing door 10R for the maintenance of the compressor 4.

As illustrated in FIG. 2, the second housing 20 is a container frame having approximately a rectangular parallelepiped shape, and has approximately the same size as the coupling space 10C provided in the first housing 10. By this means, in the state where the second housing 20 is coupled with the coupling space 10C of the first housing 10, the overall outline of the compressor-mounted engine generator/welder 1 has approximately a rectangular parallelepiped shape as illustrated in FIG. 1. Therefore, the compressor-mounted engine generator/welder 1 allows for compact accommodation of the engine 2, the generator 3, and the compressor 4 in the first housing 10 and the second housing 2, and does not have any dead space around them.

As illustrated in FIG. 2, the second housing 20 accommodates a main body 4A of the compressor 4 and an electric motor 4B as a driving source of the compressor 4. The main body 4A and the electric motor 4B are coupled with one another via a necessary power transmission mechanism 4C. An air tank 4T is disposed above the main body 4A of the compressor 4 so as to protrude upward from the frame of the second housing 20. In addition, the second housing 20 includes an exhaust port and an intake port for the compressor 4 provided at appropriate positions (not illustrated).

As illustrated in FIG. 4, in the compressor-mounted engine generator/welder 1, a first accommodation space 1A is formed inside the main body 10A and the protrusion part 10B of the first housing 10, and the engine 2 and the generator 3 are accommodated in the first accommodation space 1A. The engine 2 and the generator 3 are coupled with one another via a power transmission device (not illustrated) in the first accommodation space 1A. The generator 3 is driven by the driving force of the engine 2.

In addition, a second accommodation space 1B is formed in the second housing 20 and a part of the protrusion part 10B. The second accommodation space 1B accommodates the compressor 4 including the air tank 4T.

A partition wall 1A1 is provided in the lower portion of the protrusion part 10B of the first housing 10. The partition wall 1A1 is provided in the first housing 10 to separate from the coupling space 10C. The exhaust port 10T3 and the intake port 10T4 for the compressor 4 are provided on the protrusion part 10B of the first housing 10 under the partition wall 1A1.

The partition wall 1A1 is provided so that the air tank 4T protruding upward from the second housing 20 is spatially separated from the muffler 2B of the engine 2 in the protrusion part 10B of the first housing 10. This prevents the heat of the muffler 2B from adversely affecting the air tank 4T.

In addition, the partition wall 1A1 serves to keep the heat balance in the first housing 10. That is, the partition wall 1A1 allows the exhaust ports 10T1 and the intake ports 10T2 for the engine 2 and the generator 3 provided on the first housing 10 to make the heat balance the same between when the second housing 20 is coupled with the first housing 10 and when the second housing 20 is separated from the first housing 1. By this means, it is possible to allow the engine 2 and the generator 3 to operate in the same way between when the second housing 20 is coupled with the first housing 10 and when the second housing 20 is separated from the first housing 1. Consequently, even when the second housing 20 is separated, it is possible to drive the engine 2 and the generator 3 to operate as an engine generator/welder independently.

A piping space 1C is formed in the pedestal 10D of the first housing 10. An air pipe 6 to supply compressed air is provided in the piping space 1C. An air pipe coupler 6A is provided on one end of the air pipe 6 on the second accommodation space 1B side. An air exhaust end 4P of the compressor 4 is removably connected to the air pipe coupler 6A. Meanwhile, the other end of the air pipe 6 is connected to an air exhaust port 6B provided on a side wall (for example, the front wall) 11 of the first housing 10. Here, with the illustrated example, the piping space 1C is provided in the pedestal 10D. However, the piping space 1C may be provided anywhere in the first housing 10. For example, a free space in the main body 10A of the first housing 10 may be utilized as the piping space 1C.

Moreover, a power supply wire connection 7 to supply the power generated by the generator 3 to the electric motor 4B of the compressor 4 is provided in the first housing 10. One end of a power supply wire 8 is connected to a power output terminal of the generator 3, and the other end is connected to the power supply wire connection 7. In addition, one end of a power supply wire 9 is connected to the power supply terminal of the motor of the compressor 4, and the other end is removably connected to the power supply wire connection 7.

To separate the second housing 20 from the first housing 10, the fastening members 30 coupling the first housing 10 with the second housing 20 are removed; the power supply wire 9 is removed from the power supply wire connection 7; and the air discharge end 4P of the compressor 4 is removed from the air pipe coupler 6A. By this means, the second housing 20 is fully separated from the first housing 10. Then, the terminal of the power supply wire 9 is connected to another power source, and therefore it is possible to operate the compressor 4 accommodated in the second housing 20 independently.

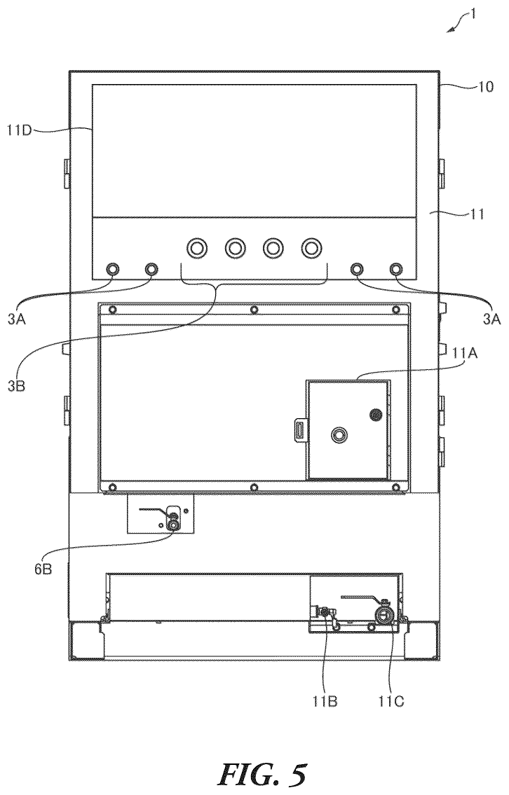

An operation panel as illustrated in FIG. 5 is formed on the side wall (for example, the front wall) 11 of the first housing 10. The air discharge port 6B is provided on the side wall 11 of the first housing 10 as described above, and one end of an air hose 40 for gouging is connected to the air discharge port 6B as illustrated in FIG. 4. In addition, welding output terminals 3A of the generator 3 are provided on the side wall 11 of the housing 10, and one end of a welding cable 41 is connected to the minus terminal of the welding output terminals 3A as illustrated in FIG. 4. Moreover, in order to use the compressor-mounted engine generator/welder 1 as a generator, power output terminals 3B of the generator 3 may be provided on the side wall 11 of the first housing 10.

With the example illustrated in FIG. 5, a fuel supply port 11A, a fuel drain port 11B, an oil guard drain port 11C, and an adjustment panel 11D for various adjustments are provided on the side wall 11 of the first housing 10, in addition to the welding output terminals 3A, the power output terminals 3B, and the air discharge port 6B described above.

For the gouging, a gouging rod G is connected to a gouging torch 42 to which one end of the air hose 40 and one end of the welding cable 41 are connected as illustrated in FIG. 4. In this state, the compressor-mounted engine generator/welder 1 performs welding work while spraying base metal (object to be welded) M with compressed air via the air hose 40. In this case, one end of an earth cable 43 is connected to the base metal M via an earth grip 44, and the other end of the earth cable 43 is connected to, for example, the plus terminal of the welding output terminals 3A.

According to this compressor-mounted engine generator/welder 1, the second housing 20 is removably coupled with the first housing 10. By this means, it is possible to carry the first housing 10 and the second housing 20 separately from one another, and therefore to improve the portability of the machine body. In addition, the second housing 20 is coupled with the coupling space 10C formed in the dead space below the protrusion part 10B of the first housing 10. By this means, it is possible to efficiently dispose the engine 2, the generator 3 and the compressor 4, and therefore the overall outline can be made compact.

When the maintenance of the compressor 4 is conducted, the second housing 20 is separated from the first housing 10. In this case, the second housing 20 can be easily separated simply by removing the fastening members 30; removing the air discharge end 4P of the compressor 4 from the air pipe coupler 6A; and disconnecting the power supply wire 9 from the power supply wire connection 7. In addition, it is possible to conduct the maintenance work while the separated second housing 20 is disposed in a large work space, and therefore to improve the workability. Consequently, it is possible to improve ease of maintenance of the compressor 4.

Then, in the first housing 10 separated from the second housing 20, the engine 2 and the generator 3 can be driven independently of the compressor 4. Therefore, even during the maintenance of the compressor 4, it is possible to drive the engine 2 to operate the generator 3, and consequently to continue the welding work without compressed air. Alternatively, instead of the compressor 4 which is being maintained, a separate or individual second housing 20 accommodating the compressor 4 having been maintained is prepared, and is coupled with the first housing 10. By this means, it is possible to continue to perform the gouging work. By this means, it is possible to avoid inconvenience that the on-site work is stopped for a long time due to the maintenance of the compressor 4.

Moreover, the power supply wire 9 is connected to another power source, and therefore it is possible to operate the compressor 4 stored in the separated second housing 20 regardless of driving the engine 2. By this means, even during the maintenance, it is possible to easily check the operation of the compressor 4 independently without driving the engine 2.

As a further advantage, the compressor 4 is not mechanically driven by the engine 2, but is driven by the power generated by the generator 3 driven by the engine 2, and therefore can be stably operated without being affected by the rotational fluctuation and the heat of the engine 2. Here, the power source of the compressor 4 is not limited to the electric motor 4, but a hydraulic motor or a small motor may be mounted separately.

According to the compressor-mounted engine generator/welder having the above-described features, it is possible to improve the portability by separating the second housing from the first housing, and it is possible to improve ease of maintenance of the compressor by separating the second housing in which the compressor is accommodated, from the first housing.

In addition, the engine and the generator can be driven independently in the first housing, separated from the second housing, and therefore it is possible to continue the welding work even during the maintenance of the compressor, and consequently to prevent the on-site work from being prolonged due to the maintenance. The driving source of the compressor is secured separately in the second housing, and therefore it is possible to easily check the operation of the compressor independently.

As described above, the embodiments of the present invention have been described in detail with reference to the drawings. However, the specific configuration is not limited to the embodiments, and the design can be changed without departing from the scope of the present invention. In addition, the above-described embodiments can be combined by utilizing each other's technology as long as there is no particular contradiction or problem in the purpose and configuration.

1. A compressor-mounted engine generator/welder comprising:
an engine;
a generator driven by the engine;
a compressor configured to obtain compressed air;
a first housing configured to accommodate the engine and the generator; and
a second housing configured to accommodate the compressor,
wherein the first housing includes a coupling space to removably couple the second housing.

2. The compressor-mounted engine generator/welder according to claim 1, wherein the first housing includes a partition wall to separate from the coupling space.

3. The compressor-mounted engine generator/welder according to claim 1, wherein the coupling space is provided under a protrusion part of the first housing, a muffler of the engine being accommodated in the protrusion part.

4. The compressor-mounted engine generator-welder according to claim 1, wherein:
the first housing includes an air pipe to supply the compressed air discharged by the compressor; and
an air discharge port to discharge the compressed air is provided on a side wall of the first housing.

5. The compressor-mounted engine generator/welder according to claim 4, wherein the air discharge port and a welding output terminal of the generator are provided on the side wall.

6. The compressor-mounted engine generator/welder according to claim 1, wherein the first housing includes a power supply wire connection to supply power generated by the generator to a motor of the compressor.
